(19) United States
(12) Patent Application Publication
(10) Pub. No.: US 2015/0138212 A1
(43) Pub. Date: May 21, 2015

(54) DISPLAY DRIVER IC AND METHOD OF OPERATING SYSTEM INCLUDING THE SAME

(71) Applicant: Samsung Electronics Co., Ltd., Suwon-Si (KR)

(72) Inventors: Jong Kon BAE, Seoul (KR); Do Kyung KIM, Yongin-si (KR); Soo Young WOO, Hwaseong-si (KR)

(21) Appl. No.: 14/452,950

(22) Filed: Aug. 6, 2014

(30) Foreign Application Priority Data
Nov. 19, 2013 (KR) 10-2013-0140753

(51) Int. Cl. G06T 1/20; G06T 1/60; G09G 5/18

(52) U.S. Cl. CPC G06T 1/20; G09G 5/18; G06T 1/60
USPC 345/520

(57) ABSTRACT

A method of operating a system including a host, a display driver IC, and a panel includes setting the host to support a video stream interface and transmitting a video stream from the host to the display driver IC using the video stream interface in response to an interrupt output from the display driver IC when the video stream is to be transmitted to the display driver IC.

### CROSS-REFERENCE TO RELATED APPLICATIONS

This application claims priority under 35 U.S.C. §119(a) from Korean Patent Application No. 10-2013-0140753 filed on Nov. 19, 2013, the disclosure of which is hereby incorporated by reference in its entirety.

### BACKGROUND

Embodiments of the inventive concepts relate to a data processing system, and more particularly, to a display driver IC for supporting video stream interface that enables output of a video stream in response to an interrupt output from the display driver IC and a system including the same.

Mobile Industry Processor Interface Display Serial Interface (MIPI DSI) is a recent display standard for portable electronic devices. MIPI® supports two display standards, i.e., video mode and command mode.

In video mode, frame data is transmitted in real time from a host to a display driver IC. Even when an image transmitted to the display driver IC is a still image, the host transmits the still image continuously to the display driver IC in video mode, which increases the power consumption of the host.

In command mode, the start of frame data transmission is controlled by a tearing effect (TE) signal. When a still image is displayed on a display, the display driver IC periodically reads the still image from a frame buffer included therein and transmits the still image to the display. This operation is called panel self-refresh.

### SUMMARY

According to some embodiments of the inventive concepts, a method of operating a system including a host, a display driver IC, and/or a panel is provided. The method includes setting the host to support video stream interface and transmitting a video stream from the host to the display driver IC using the video stream interface in response to an interrupt output from the display driver IC when the video stream is to be transmitted to the display driver IC.

The host may set the video stream interface using firmware. The interrupt may be a control signal for controlling transmission timing of the video stream to be transmitted to the display driver IC.

The method may further include determining by the host whether the video stream is still image data or moving image data, and controlling whether to transmit the video stream based on a result of the determination.

The video stream interface may support a mobile industry processor interface (MIPI) video mode. The video stream may include synchronous signals and data. The host may transmit the video stream to the display driver IC using a first clock. The interrupt may be a tearing effect (TE) signal.

The method may further include restoring, by the display driver IC, a data enable signal and the data from the video stream, and writing the data to a frame buffer implemented in the display driver IC using a write clock related to the first clock and the restored data enable signal. The video stream may include the first clock and the data.

Alternatively, the method may further include restoring, by the display driver IC, a data enable signal, the data, and the first clock from the video stream, and writing the restored data to a frame buffer implemented in the display driver IC using a write clock related to the restored first clock and the restored data enable signal.

As another alternative, the method may further include transmitting by the host a command for adjusting a panel refresh rate of the panel to the display driver IC, and transmitting the video stream at the panel refresh rate to the display driver IC.

The method may further include restoring, by the display driver IC, data and a data enable signal from the video stream, decoding the command and generating a decoded command, writing the restore data to a line buffer using the restored data enable signal and a first clock received from the host, generating an internal clock using an oscillator implemented in the display driver IC, and generating rate control signals for adjusting the panel refresh rate using the decoded command and the internal clock and transmitting the rate control signals to the panel.

Alternatively, the method may further include restoring, by the display driver IC, data, a clock, and a data enable signal from the video stream, which includes an embedded clock and the data, decoding the command and generating a decoded command, writing the restored data to a line buffer using the restored data enable signal and the restored clock, generating an internal clock using an oscillator implemented in the display driver IC, and generating rate control signals for adjusting the panel refresh rate using the decoded command and the internal clock and transmitting the rate control signals to the panel.

According to other embodiments of the inventive concepts, there is provided a display driver IC including a receive interface configured to receive a video stream and a clock from a host and to restore a data enable signal and data from the video stream, a frame buffer, an oscillator configured to generate an internal clock, a timing controller configured to transmit an interrupt for controlling transmission timing of the video stream using the internal signal and to generate control signals related to panel self-refresh, and a memory controller configured to write the restored data to the frame buffer using a write clock related to the clock and the restored data enable signal.

According to other embodiments of the inventive concepts, there is provided a display driver IC including a receive interface configured to receive a video stream, which includes an embedded clock and data, output from a host and to restore a data enable signal, the data, and the clock from the video stream, a frame buffer, an oscillator configured to generate an internal clock, a timing controller configured to transmit an interrupt for controlling transmission timing of the video stream using the internal clock and to generate control signals related to panel self-refresh, and a memory controller configured to write the restored data to the frame buffer using a write clock related to the clock and the restored data enable signal.

### BRIEF DESCRIPTION OF THE DRAWINGS

The above and other features and advantages of the inventive concepts will become more apparent by describing in detail exemplary embodiments thereof with reference to the attached drawings in which:

FIG. 1 is a block diagram of a data processing system according to some embodiments of the inventive concepts;

FIG. 2 is a block diagram of a data processing system according to other embodiments of the inventive concepts;

FIG. 3 is a timing diagram of the operation of the data processing system illustrated in FIG. 1 or 2;

FIG. 4 is a block diagram of a data processing system including a bridge chip and a display driver IC according to some embodiments of the inventive concepts;

FIG. 5 is a block diagram of a data processing system including a bridge chip and a display driver IC according to other embodiments of the inventive concepts;

FIG. 6 is a block diagram of a data processing system capable of adjusting a panel refresh rate according to some embodiments of the inventive concepts;

FIG. 7 is a block diagram of a data processing system capable of adjusting a panel refresh rate according to other embodiments of the inventive concepts;

FIG. 8 is a timing diagram of a video stream transmitted according to a panel refresh rate adjusted by the data processing system illustrated in FIG. 6 or 7;

FIG. 9 is a flowchart of a method of operating the data processing system illustrated in FIG. 1 or 2 according to some embodiments of the inventive concepts; and

FIG. 10 is a flowchart of a method of operating the data processing system illustrated in FIG. 6 or 7 according to some embodiments of the inventive concepts.

### DETAILED DESCRIPTION OF THE EMBODIMENTS

The inventive concepts now will be described more fully hereinafter with reference to the accompanying drawings, in which embodiments are shown. This example embodiments may, however, be embodied in many different forms and should not be construed as limited to the embodiments set forth herein. Rather, these embodiments are provided so that this disclosure will be thorough and complete, and will fully convey the scope of the example embodiments to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the example embodiments. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this example embodiments belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

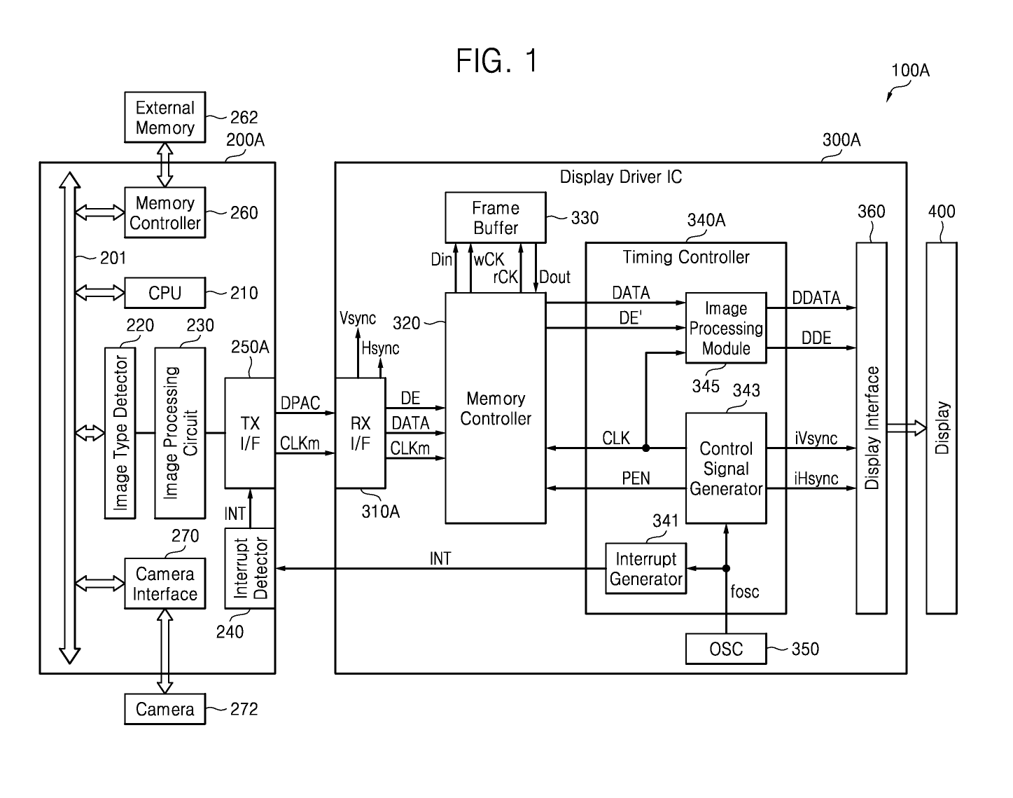

FIG. 1 is a block diagram of a data processing system 100A according to some embodiments of the inventive concepts. The data processing system 100A includes a host 200A, an external memory 262, a camera 272, a display driver IC (which may be referred to as a DDI) 300A, and a display (or a panel) 400.

The data processing system 100A is a system that can process a video stream (e.g., still image data or moving image data) and can display a processed video stream (or display data DDATA) on the display 400.

The data processing system 100A may be implemented as a smart phone, a tablet personal computer (PC), a digital camera, a camcorder, a personal digital assistant (PDA), a portable multimedia player (PMP), a mobile internet device (MID), or a wearable computer.

Here, the collective name for data processing systems 100A, 100A-1, 100B, 100B-1, 100C, and 100C-1, which will be described hereinafter, is a data processing system.

The host 200A may support a video stream interface. Here, supporting the video stream interface covers all of cases where the host 200A supports the video stream interface in hardware and where the host 200A is set to support the video stream interface in hardware using firmware (or software) that drives the host 200A.

For instance, when the host 200A support Mobile Industry Processor Interface (MIPI) video mode only, the host 200A can support the video stream interface. In another instance, when the host 200A can support both MIPI video mode and MIPI command mode, and the host 200A is set to support only MIPI video mode by firmware (or software), the host 200A can support the video stream mode. However, the host 200A that supports only MIPI command mode cannot support the video stream interface.

The host 200A may control the external memory 262, the camera 272, and/or the display driver IC 300A. The host 200A may be implemented as a system on chip (SoC), a processor, an application processor (AP), or a mobile AP. The host 200A includes a bus 201, a central processing unit (CPU) 210, an image type detector 220, an image processing circuit 230, an interrupt detector 240, a transmit interface (TX I/F) 250A, a memory controller 260, and a camera interface 270.

The CPU 210 may control the operation of at least one of the elements 220, 230, 240, 250A, 260, and 270 through a bus 201. In other embodiments, the CPU 210 may control a TX I/F 250B, 250C, or 250D. The CPU 210 may execute firmware (or software) that may configure the host 200A to support a video stream interface. The firmware may be loaded from the external memory 262 to the host 200A. For instance, the CPU 210 may include one or more cores.

The image type detector 220 may detect (or determine) whether image data to be transmitted to the display driver IC 300A is still image data or moving image data and may control the transmission of the image data (which may be referred to as “video data”) based on the detection (or determination) result. In other words, the image type detector 220 may determine whether to transmit the image data to the image processing circuit 230.

For instance, when the image data output from an image data source (i.e., the external memory 262 or the camera 272) is still image data, the image type detector 220 may transmit the image data to the image processing circuit 230 at 1 Hz.

In another instance, when the image data output from the image data source 262 or 272 is moving image data, the image type detector 220 may transmit the image data to the image processing circuit 230 at 60 Hz. Accordingly, the image type detector 220 may send the image processing circuit 230 only image data that needs to be transmitted (or image data which the display 400 needs to be updated with), thereby preventing unnecessary image data transmission.

Although the image type detector 220 is placed between the bus 201 and the image processing circuit 230 in the embodiments illustrated in FIG. 1, the image processing circuit 230 may be placed between the bus 201 and the image type detector 220 in other embodiments. The image processing circuit 230 may convert image data output from the image type detector 220 into a format that can be processed by the TX I/F 250A.

The interrupt detector 240 may detect an interrupt INT output from the display driver IC 300A and generate a detection signal. The detection signal may be different from or the same as the interrupt INT. However, since the detection signal is related to the interrupt INT, both the detection signal and the interrupt are denoted by INT and collectively referred to as an interrupt.

For instance, the TX I/F 250A may function as an interface that can support the video stream interface. The TX I/F 250A may convert image data output from the image processing circuit 230 into a video stream DPAC and may adjust the transmission timing of the video stream DPAC based on the interrupt INT.

At this time, the video stream DPAC may include synchronous signals and data. The synchronous signals may be signals related to a vertical synchronous signal, a horizontal synchronous signal, and a data enable signal that will be restored in the display driver IC 300A. Therefore, the interrupt INT may function as a control signal for controlling the transmission timing of the video stream DPAC to be transmitted to the display driver IC 300A.

For instance, the interrupt INT may be a tearing effect (TE) signal that can reduce or prevent TE when the data processing system 100A supports MIPI®. In another instance, the interrupt INT may be a control signal that is output from the display driver IC 300A to control the transmission timing of the video stream DPAC when the data processing system 100A supports embedded DisplayPort (eDP).

The TX I/F 250A may support MIPI, eDP, or high-speed serial interface.

The memory controller 260 may interface image data between the host 200A and the external memory 262. For instance, according to the control of the memory controller 260, image data output from the host 200A may be stored in the external memory 262 and image data output from the external memory 262 may be transmitted to the bus 201. The external memory 262 may be a dynamic random access memory (DRAM), a solid state drive (SSD), a multimedia card (MMC), an embedded MMC (eMMC), a universal serial bus (USB) flash drive, or a universal flash storage (UFS).

The external memory 262 illustrated in FIG. 1 may be a set of different types of memories. Accordingly, the external memory 262 may be a set of DRAM and eMMC. An operating system (OS) may be loaded from the eMMC to the DRAM to be executed. When the external memory 262 is a set of memories, the memory controller 260 may be a set of different controllers for controlling different types of memories.

The camera interface 270 may transmit image data output from the camera 272 to the bus 201. For instance, the camera 272 may be implemented as a complementary metal oxide semiconductor (CMOS) image sensor. The host 200A may also include one or more wireless interfaces that can perform wireless communication with other devices. Therefore, the host 200A may receive image data through wireless connection, e.g., Wi-Fi, wireless internet, or long term evolution (LTE™), using the wireless interface(s). In addition, the data processing system 100A may support Camera 2.0.

As described above, the host 200A set to support video stream interface may transmit the video stream DPAC to the display driver IC 300A through the video stream interface according to the interrupt INT output from the display driver IC 300A when (or whenever) the transmission of the video stream DPAC to the display driver IC 300A is necessary.

The host 200A and the display driver IC 300A may be connected with each other through a first transmission line (or lane) for the transmission of the video stream DPAC and a second transmission line (or lane) for the transmission of a clock CLKm. For instance, the video stream DPAC may be transmitted in synchronization with the clock CLKm. Each of the video stream DPAC and the clock CLKm may be differential signals.

The display driver IC 300A may perform panel self-refresh on the display (or panel) 400. The display driver IC 300A includes a receive interface (RX I/F) 310A, a memory controller 320, a frame buffer 330, a timing controller 340A, an oscillator (OSC) 350, and a display interface 360.

The RX I/F 310A receives the video stream DPAC and the clock (or clock signal) CLKm from the host 200A, restores a vertical synchronous signal Vsync, a horizontal synchronous signal Hsync, a data enable signal DE and data DATA from the video stream DPAC using the clock CLKm, and bypasses the clock CLKm to the memory controller 320. The data enable signal DE is an indicator that indicates valid data. When the data enable signal DE is activated, data is valid. When the data enable signal DE is deactivated, data is invalid.

The data enable signal DE, the data DATA, and the clock CLKm are transmitted to the memory controller 320. In the embodiments of the inventive concepts, the vertical synchronous signal Vsync and the horizontal synchronous signal Hsync are not used in processing the data DATA. Accordingly, the RX I/F 310A may not output the vertical synchronous signal Vsync and the horizontal synchronous signal Hsync.

The memory controller 320 writes data Din (=DATA) to the frame buffer 330 using the data enable signal DE that has been activated and a write clock wCK. The write clock wCK is related to the clock CLKm and a frequency of the write clock wCK may be the same as or different from a frequency of the clock CLKm. For instance, the memory controller 320 may include a first frequency divider (not shown), which may divide the frequency of the clock CLKm to generate the write clock wCK. The data Din (=DATA) written to the frame buffer 330 may be used for panel self-refresh.

The memory controller 320 generates a read clock rCK using a read enable signal PEN and a clock CLK and reads data Dout (=DATA) from the frame buffer 330 using the read clock rCK. The read clock rCK is related to the clock CLK and a frequency of the read clock rCK may be the same as or different from a frequency of the clock CLK. For instance, the memory controller 320 may also include a second frequency divider (not shown), which divides the frequency of the clock CLK to generate the read clock rCK.

The read enable signal PEN may function as a panel self-refresh enable signal for controlling panel self-refresh. Whenever the read enable signal PEN is activated, the memory controller 320 may generate the read clock rCK and read the data Dout (=DATA) from the frame buffer 330 using the read clock rCK.

The memory controller 320 generates a data enable signal DE′ using the clock CLK and transmits the data enable signal DE′ and the read data DATA (=Dout) to the timing controller 340A. The data enable signal DE′ may function as an indicator for indicating a valid interval of the read data DATA (=Dout). The OSC 350 generates an internal clock fosc.

The timing controller 340A may control panel self-refresh using control signals PEN, CLK, iVsync, and iHsync generated based on the internal clock fosc.

The timing controller 340A includes an interrupt generator 341, a control signal generator 343, and an image processing module 345.

The interrupt generator 341 periodically generates the interrupt INT based on the internal clock fosc. The interrupt INT may have a frequency of 60 Hz. When the image processing system 100A supports MIPI, the interrupt generator 341 may function as a TE signal generator that generates a TE signal as the interrupt INT.

The control signal generator 343 generates the read enable signal PEN and the clock CLK based on the internal clock fosc.

When panel self-refresh is performed by the display driver IC 300A, the memory controller 320 may perform a scan operation using the clock CLK and the read enable signal PEN that is periodically activated. The scan operation includes reading the data DATA necessary for the panel self-refresh from the frame memory 330 and transmitting the read data DATA (=Dout) to the display 400 via the timing controller 340A and the display interface 360.

The clock CLK may be generated using the internal clock fosc and a frequency of the clock CLK may be the same as or different from a frequency of the internal clock fosc. According to some embodiments, the data enable signal DE′ may be the same as or different from the read enable signal PEN.

The control signal generator 343 may also generate the internal vertical synchronous signal iVsync and an internal horizontal synchronous signal iHsync based on the internal clock fosc. The internal vertical synchronous signal iVsync is a vertical synchronous signal related to the display of display data DDATA and the internal horizontal synchronous signal iHsync is a horizontal synchronous signal related to the display of the display data DDATA.

The image processing module 345 may receive the clock CLK, the data enable signal DE′ and the read data DATA (=Dout), process the read data DATA (=Dout) using the clock CLK and the data enable signal DE′, and generate a data enable signal DDE and the display data DDATA as the processing results.

The data enable signal DDE may function as an indicator for indicating a valid interval of the display data DDATA. For instance, the image processing module 345 may also perform image enhancement and/or image editing. For instance, the image processing module 345 may adjust the brightness, contrast, saturation, and/or sharpness of the read data DATA (=Dout) and generate the display data DDATA corresponding to the adjustment result.

The display interface 360 may receive the internal vertical synchronous signal iVsync, the internal horizontal synchronous signal iHsync, the data enable signal DDE and the display data DDATA, and may drive the display 400 for panel self-refresh using these signals iVsync, iHsync, DDE and DDATA. For instance, the display interface 360 may function as a driver and therefore transmit analog signals corresponding to the display data DDATA to data lines arranged in the display 400.

The display 400 may be implemented as a thin-film-transistor liquid-crystal display (TFT-LCD), a light-emitting diode (LED) display, an organic LED (OLED) display, an active-matrix OLED (AMOLED) display, or a flexible display.

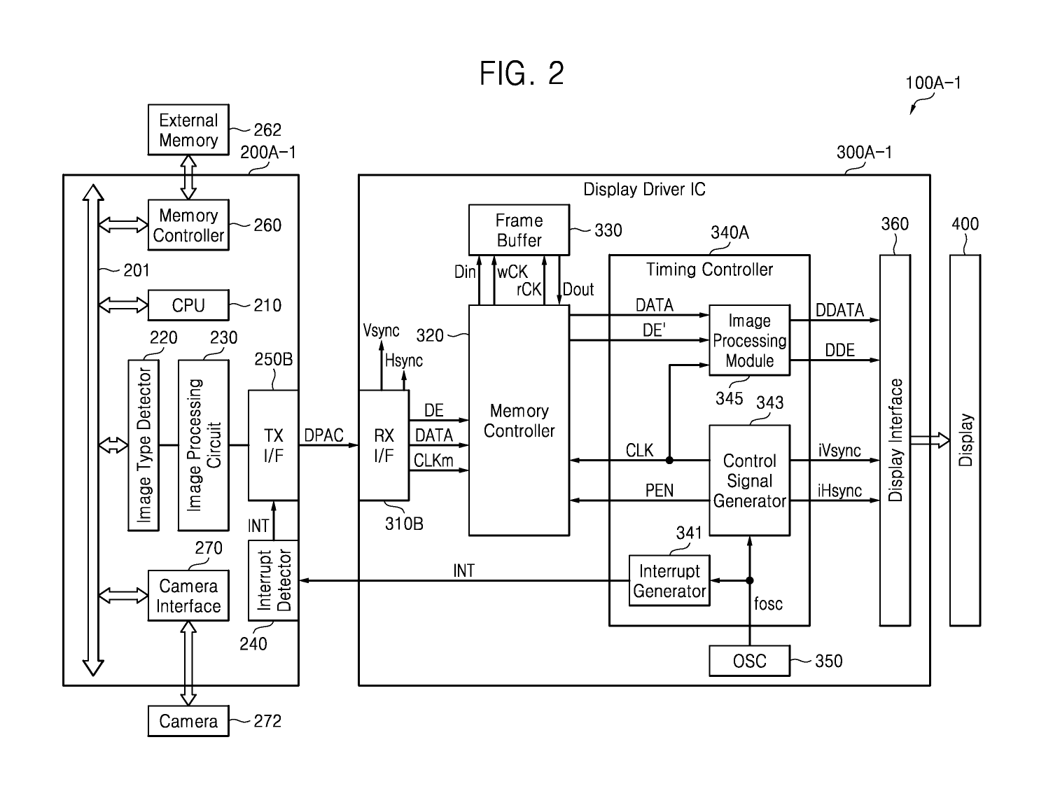

FIG. 2 is a block diagram of a data processing system 100A-1 according to other embodiments of the inventive concepts. Apart from the functions of a TX I/F 250B and an RX I/F 310B, the structure and operations of the data processing system 100A-1 illustrated in FIG. 2 are substantially the same as those of the data processing system 100A illustrated in FIG. 1.

TX I/F 250B of a host 200A-1 may transmit the video stream DPAC including the clock CLKm and the data DATA to a display driver IC 300A-1 in response to the interrupt INT.

Apart from the TX I/F 250A and the TX I/F 250B, the structure and operations of the host 200A-1 illustrated in FIG. 2 are substantially the same as those of the host 200A illustrated in FIG. 1. Apart from the RX I/F 310A and the RX I/F 310B, the structure and operations of the display driver IC 300A-1 illustrated in FIG. 2 are substantially the same as those of the display driver IC 300A illustrated in FIG. 1. For instance, the interfaces 250B and 310B may be implemented as interfaces supporting eDP.

The RX I/F 310B of the display driver IC 300A-1 may receive the video stream DPAC including the clock CLKm and the data DATA and may restore the vertical synchronous signal Vsync, the horizontal synchronous signal Hsync, the data enable signal DE, the data DATA, and the clock CLKm from the video stream DPAC using the clock CLKm. At this time, the video stream DPAC including the clock CLKm and the data DATA may be transmitted through a single transmission line.

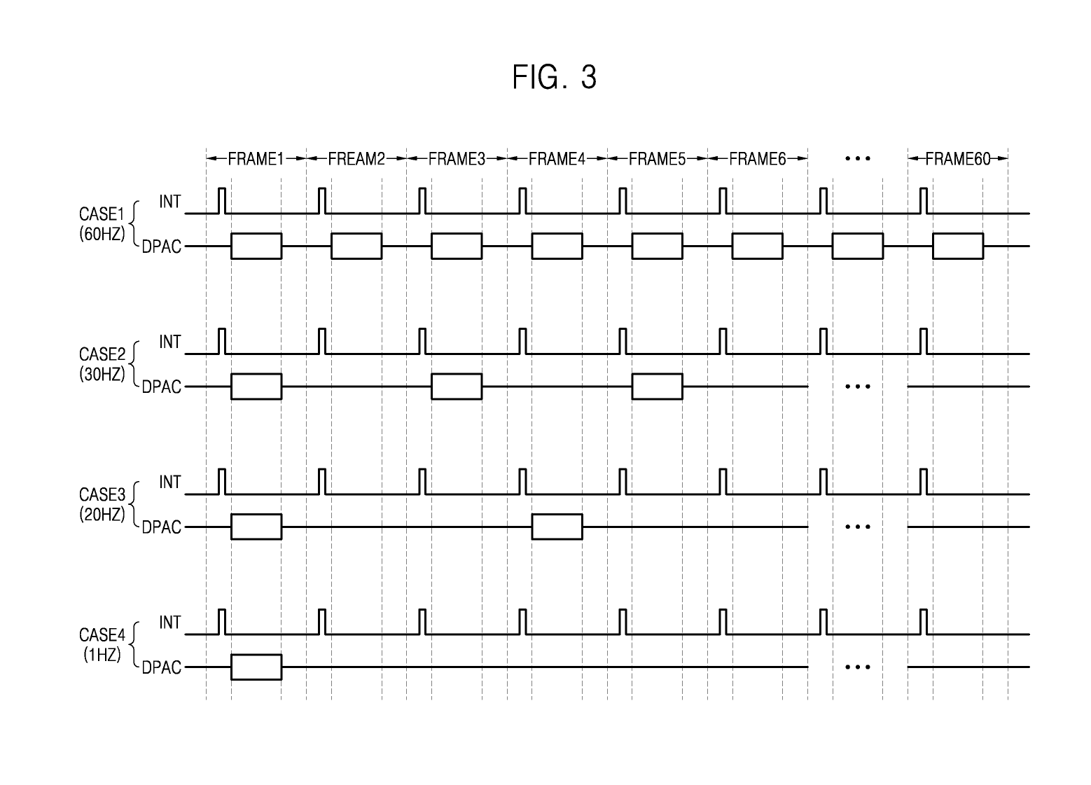

FIG. 3 is a timing diagram of the operation of the data processing system 100A or 100A-1 illustrated in FIG. 1 or 2.

Referring to FIGS. 1 through 3, in a first case CASE1 when the host 200A or 200A-1 transmits moving image data, i.e., the video stream DPAC to the display driver IC 300A or 300A-1 at 60 Hz, the host 200A or 200A-1 may transmit the video stream DPAC for each of frames FRAME1 through FRAME60 to the display driver IC 300A or 300A-1 in response to the interrupt INT.

At this time, the display driver IC 300A or 300A-1 may transmit the display data DDATA corresponding to each of the frames FRAME1 through FRAME60 to the display 400 using the frame buffer 330. Accordingly, a moving image corresponding to the display data DDATA is displayed on the display 400.

In a second case CASE2, when the host 200A or 200A-1 transmits moving image data, i.e., the video stream DPAC to the display driver IC 300A or 300A-1 at 30 Hz, the host 200A or 200A-1 may transmit the video stream DPAC for each of odd-numbered frames FRAME1, FRAME3, FRAME5, . . . to the display driver IC 300A or 300A-1 in response to the interrupt INT.

For instance, the display driver IC 300A or 300A-1 stores the data DATA corresponding to the video stream DPAC of the first frame FRAME1 in the frame buffer 330 and transmits the display data DDATA corresponding to the data DATA stored in the frame buffer 330 to the display 400.

When the video stream DPAC corresponding to the second frame FRAME2 does not need to be transmitted to the display driver IC 300A or 300A-1, the host 200A or 200A-1 does not transmit the video stream DPAC corresponding to the second frame FRAME2 to the display driver IC 300A or 300A-1. Therefore, the display driver IC 300A or 300A-1 transmits the display data DDATA corresponding to the data DATA output from the frame buffer 330 to the display 400 for panel self-refresh, that is, performs the scan operation.

For the second frame FRAME2, the display 400 displays the display data DDATA corresponding to the video stream DPAC of the first frame FRAME 1. In other words, in the first and second frames FRAME1 and FRAME2, the same display data DDATA is displayed through panel self-refresh.

In a third case CASE3, when the host 200A or 200A-1 transmits moving image data, i.e., the video stream DPAC to the display driver IC 300A or 300A-1 at 20 Hz, the host 200A or 200A-1 may transmit the video stream DPAC for each of the frames FRAME1, FRAME4, . . . to the display driver IC 300A or 300A-1 in response to the interrupt INT.

For instance, the display driver IC 300A or 300A-1 stores the data DATA corresponding to the video stream DPAC of the first frame FRAME1 in the frame buffer 330 and transmits the display data DDATA corresponding to the data DATA stored in the frame buffer 330 to the display 400.

When the video stream DPAC corresponding to each of the second and third frames FRAME2 and FRAME3 does not need to be transmitted to the display driver IC 300A or 300A-1, the host 200A or 200A-1 does not transmit the video stream DPAC corresponding to each of the second and third frames FRAME2 and FRAME3 to the display driver IC 300A or 300A-1. Therefore, the display driver IC 300A or 300A-1 transmits the display data DDATA corresponding to the data DATA output from the frame buffer 330 to the display 400 for panel self-refresh.

For the second and third frames FRAME2 and FRAME3, the display 400 displays the display data DDATA corresponding to the video stream DPAC of the first frame FRAME1. In other words, in the first through third frames FRAME1 through FRAME3, the same display data DDATA is displayed through panel self-refresh.

In a fourth case CASE4, when the host 200A or 200A-1 transmits still image data, i.e., the video stream DPAC to the display driver IC 300A or 300A-1 at 1 Hz, the host 200A or 200A-1 may transmit the video stream DPAC corresponding to the first frame FRAME1 to the display driver IC 300A or 300A-1 in response to the interrupt INT.

For instance, the display driver IC 300A or 300A-1 stores the data DATA corresponding to the video stream DPAC of the first frame FRAME1 in the frame buffer 330 and transmits the display data DDATA corresponding to the data DATA stored in the frame buffer 330 to the display 400.

In the second through 60th frames FRAME2 through FRAME60, the display driver IC 300A or 300A-1 transmits the display data DDATA corresponding to the data DATA output from the frame buffer 330 to the display 400 for panel self-refresh.

For the second through 60th frames FRAME2 through FRAME60, the display 400 displays the display data DDATA corresponding to the video stream DPAC of the first frame FRAME 1. In other words, in the first through 60th frames FRAME 1 through FRAME60, the same display data DDATA is displayed through panel self-refresh.

As described above, the host 200A or 200A-1 may transmit the video stream DPAC to the display driver IC 300A or 300A-1 in response to the interrupt INT only when the video stream DPAC needs to be transmitted to the display driver IC 300A or 300A-1.

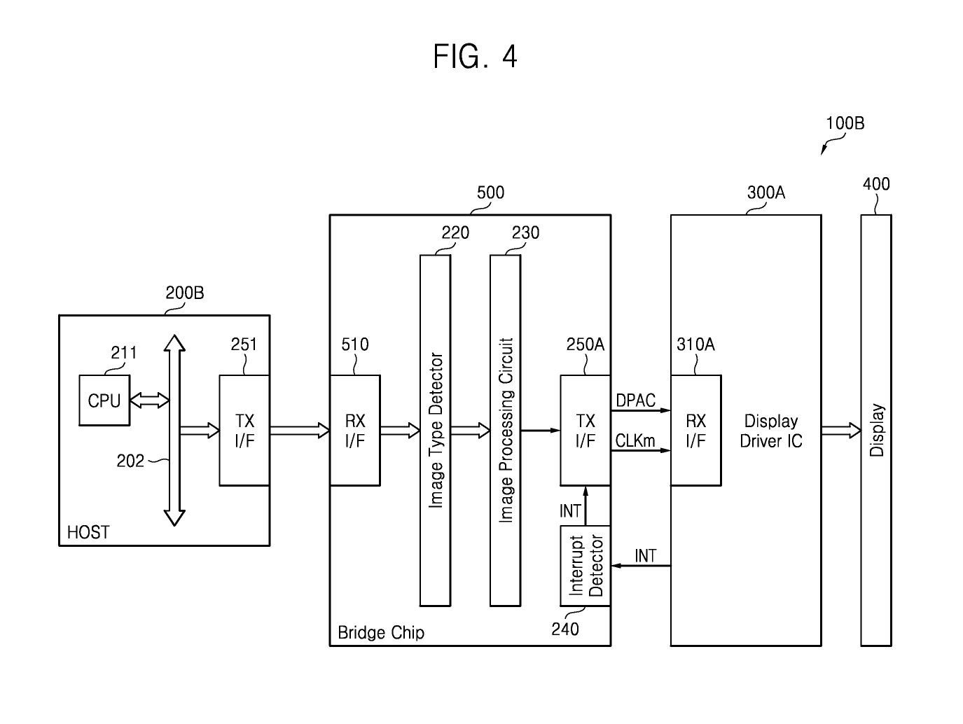

FIG. 4 is a block diagram of a data processing system 100B including a bridge chip 500 and the display driver IC 300A according to some embodiments of the inventive concepts. Referring to FIGS. 1 and 4, the data processing system 100B includes a host 200B, the bridge chip 500, the display driver IC 300A, and the display 400.

The host 200B may be cheaper than the host 200A or 200A-1. The host 200B may control the bridge chip 500. The host 200B includes a bus 202, a CPU 211, and a TX I/F 251. The CPU 211 may transmit image data (e.g., still image data or moving image data) to the TX I/F 251 through the bus 202.

The host 200B may include a plurality of image data sources. The image data sources may be an external memory and a camera. Accordingly, the host 200B may also include a memory controller performing the same function as the memory controller 260 that interfaces with the external memory and a camera interface performing the same function as the camera interface 270 that interfaces with the camera.

The TX I/F 251 may communicate with an RX I/F 510 included in the bridge chip 500. For instance, the interfaces 251 and 510 may support an RGB interface or a low-voltage differential signaling (LVDS) interface. The bridge chip 500 may include the RX I/F 510, the image type detector 220, the image processing circuit 230, the interrupt detector 240, and the TX I/F 250A.

The structure and operations of the elements 220, 230, 240, 250A, and 310A illustrated in FIG. 4 are substantially the same as those of the elements 220, 230, 240, 250A, and 310A illustrated in FIG. 1. When the bridge chip 500 functions as a host with respect to the display driver IC 300A, the host 200B may function as a main host with respect to the bridge chip 500.

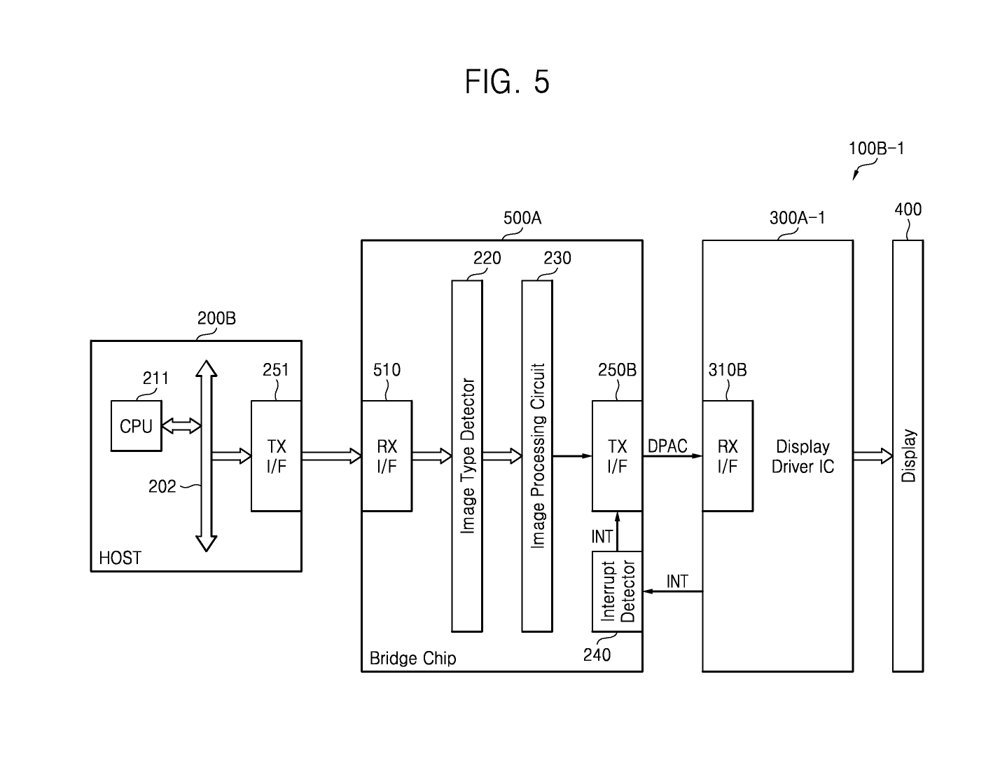

FIG. 5 is a block diagram of a data processing system 100B-1 including a bridge chip 500A and the display driver IC 300A-1 according to other embodiments of the inventive concepts. Referring to FIGS. 2 and 5, the data processing system 100B-1 includes the host 200B, the bridge chip 500A, the display driver IC 300A-1, and the display 400. The host 200B may control the bridge chip 500A.

The bridge chip 500A may include the RX I/F 510, the image type detector 220, the image processing circuit 230, the interrupt detector 240, and the TX I/F 250B. The structure and operations of the elements 220, 230, 240, 250B, and 310B illustrated in FIG. 5 are substantially the same as those of the elements 220, 230, 240, 250B, and 310B illustrated in FIG. 2.

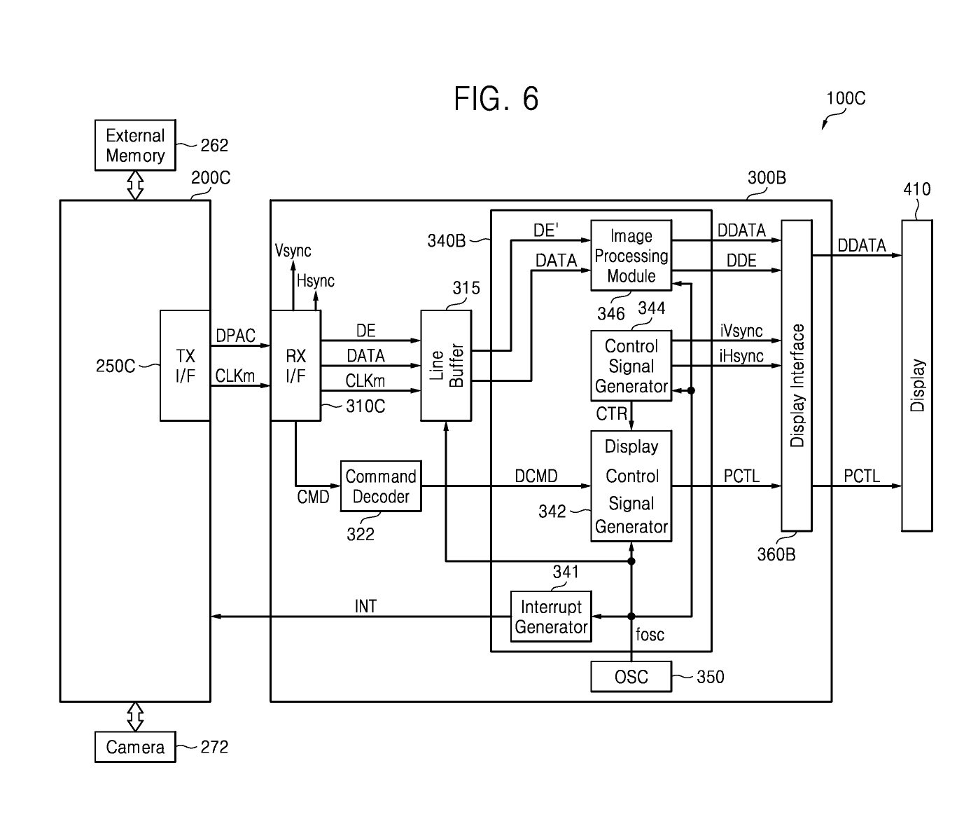

FIG. 6 is a block diagram of a data processing system 100C capable of adjusting a panel refresh rate according to some embodiments of the inventive concepts. Referring to FIG. 6, the data processing system 100C includes a host 200C, the external memory 262, the camera 272, a display driver IC 300B, and a display (or panel) 410.

Apart from a TX I/F 250C, the structure and operations of the host 200C illustrated in FIG. 6 are substantially the same as those of the host 200A illustrated in FIG. 1. The host 200C may output a command for adjusting a panel refresh rate of the display 410 to the display driver IC 300B. Here, the command collectively indicates at least one bit or at least one control signal for adjusting the panel refresh rate.

Referring to FIGS. 1 and 6, the CPU 210 or the image type detector 220 in the host 200C may generate the command for adjusting the panel refresh rate based on the type of the video stream DPAC to be transmitted to the display driver IC 300B. The host 200C may generate the command when it is necessary to adjust the panel refresh rate.

The panel refresh rate is fixed to 60 Hz in the data processing system 100A or 100A-1 illustrated in FIG. 1 or 2. However, the panel refresh rate of the data processing system 100D may be variously changed according to the structural feature of the display 410.

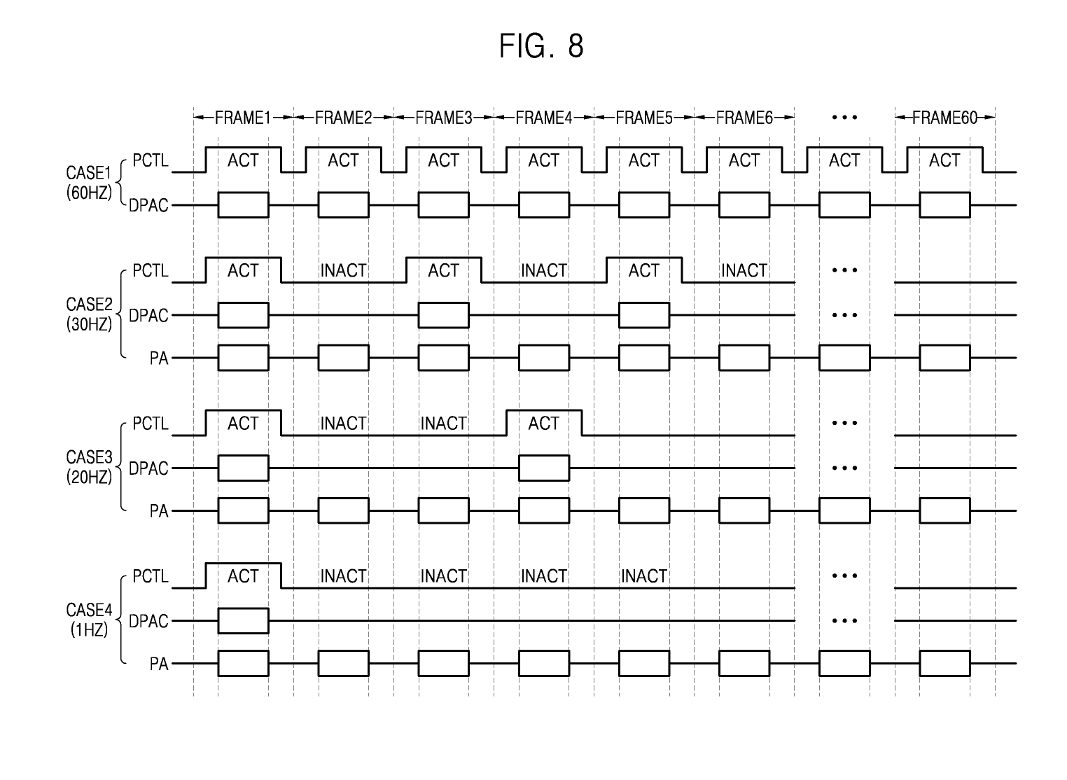

As shown in FIG. 8, the panel refresh rate of the display 410 may be changed from 60 Hz to 30, 20 and 1 Hz according to the control of the host 200C. The panel refresh rate illustrated in FIG. 8 is just an example provided for convenience' sake in the description.

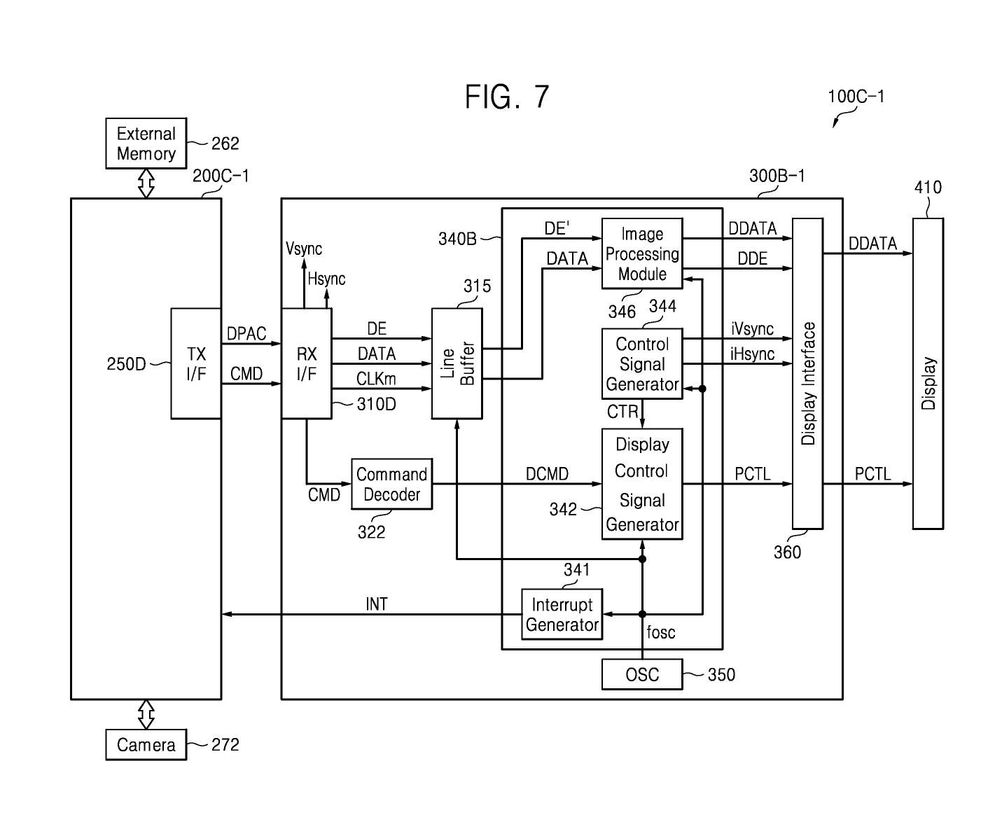

According to embodiments, the command may be included in the video stream DPAC as shown in FIG. 6 or may be a separate command CMD from the video stream DPAC as shown in FIG. 7.

A method of defining the command for adjusting the panel refresh rate of the display 410, a time of generation of the command, and/or a method of transmitting the command to the display driver IC 300B may be variously changed by a designer of the data processing system 100C or 100C-1.

The TX I/F 250C transmits the video stream DPAC including the command CMD, synchronous signals, and the data DATA through a first transmission line and the clock CLKm through a second transmission line to the display driver IC 300B.

The display driver IC 300B includes an RX I/F 310C, a line buffer 315, a command decoder 322, a timing controller 340B, the OSC 350, and a display interface 360B.

The RX I/F 310C receives the video stream DPAC and the clock CLKm from the host 200C, restores the vertical synchronous signal Vsync, the horizontal synchronous signal Hsync, the data enable signal DE and the data DATA from the video stream DPAC using the clock CLKm, and bypasses the clock CLKm to the line buffer 315.

The RX I/F 310C also extracts the command CMD from the video stream DPAC using the clock CLKm and transmits the command CMD to the command decoder 322.

The line buffer 315 may store valid data DATA based on the clock CLKm and the data enable signal DE. The command decoder 322 decodes the command CMD output from the RX I/F 310C and transmits a decoded command DCMD to a display control signal generator 342. The OSC 350 generates the internal clock fosc.

The line buffer 315 outputs the data DATA using the internal clock fosc. For instance, the line buffer 315 may also generate the data enable signal DE′ indicating a valid interval of the data DATA using the internal clock fosc.

The timing controller 340B may control a panel refresh rate for the display of the display data DDATA using control signals PCTL, iVsync, and iHsync generated based on the decoded command DCMD and the internal clock fosc.

The timing controller 340B includes the interrupt generator 341, the display control signal generator 342, a control signal generator 344, and an image processing module 346.

The interrupt generator 341 periodically generates the interrupt INT based on the internal clock fosc. For instance, a frequency of the interrupt INT may be 60 Hz.

The display control signal generator 342 may generate the rate control signals PCTL for adjusting the panel refresh rate in response to the decoded command DCMD, the internal clock fosc, and a control signal CTR.

The control signal generator 344 may generate the internal vertical synchronous signal iVsync, the internal horizontal synchronous signal iHsync, and the control signal CTR based on the internal clock fosc.

The internal vertical synchronous signal iVsync is a vertical synchronous signal related to the display of the display data DDATA and the internal horizontal synchronous signal iHsync is a horizontal synchronous signal related to the display of the display data DDATA. The control signal CTR may be a signal for controlling the generation timing of the rate control signals PCTL. For instance, the control signal CTR may include the internal vertical synchronous signal iVsync and the internal horizontal synchronous signal iHsync.

The image processing module 346 receives the internal clock fosc, the data enable signal DE′ and the data DATA, processes the data DATA using the internal clock fosc and the data enable signal DE′, and generates the data enable signal DDE and the display data DDATA as the processing results.

As described above, the image processing module 346 may perform image enhancement and/or image editing. For instance, the image processing module 346 may adjust the brightness, contrast, saturation, and/or sharpness of the data DATA and generate the display data DDATA corresponding to the adjustment result.

The display interface 360B may receive the internal vertical synchronous signal iVsync, the internal horizontal synchronous signal iHsync, the rate control signals PCTL, the data enable signal DDE and the display data DDATA, and may drive the display 410 for panel refresh using these signals iVsync, iHsync, PCTL, DDE and DDATA. The display 410 may be implemented as an oxide TFT-LCD.

FIG. 7 is a block diagram of a data processing system 100C-1 capable of adjusting a panel refresh rate according to other embodiments of the inventive concepts. Apart from a TX I/F 250D and an RX I/F 310D, the structure and operations of the data processing system 100C-1 illustrated in FIG. 7 are substantially the same as those of the data processing system 100C illustrated in FIG. 6.

Apart from the TX I/F 250D, the structure and operations of a host 200C-1 illustrated in FIG. 7 are substantially the same as those of the host 200A illustrated in FIG. 1. Referring to FIGS. 1 and 7, the CPU 210 or the image type detector 220 in the host 200C-1 may generate the command CMD for adjusting the panel refresh rate based on the type of the video stream DPAC to be transmitted to the display driver IC 300B-1.

The host 200C-1 may generate the command CMD when it is necessary to adjust the panel refresh rate. The host 200C-1 may transmit the video stream DPAC including the clock CLKm and the data DATA through a first transmission line and the command CMD through a second transmission line to the display driver IC 300B-1. Apart from the RX I/F 310D, the structure and operations of the display driver IC 300B-1 illustrated in FIG. 7 are substantially the same as those of the display driver IC 300B illustrated in FIG. 6.

The RX I/F 310D restores the vertical synchronous signal Vsync, the horizontal synchronous signal Hsync, the data enable signal DE, the data DATA, and the clock CLKm from the video stream DPAC and transmits the data enable signal DE, the data DATA, and the clock CLKm to the line buffer 315. The RX I/F 310D transmits the command CMD to the command decoder 322.

FIG. 8 is a timing diagram of the video stream DPAC transmitted according to a panel refresh rate adjusted by the data processing system 100C or 100C-1 illustrated in FIG. 6 or 7.

Referring to FIGS. 6 through 8, in a first case CASE1, when the panel refresh rate is 60 Hz, the host 200C or 200C-1 transmits the video stream DPAC for each of the frames FRAME1 through FRAME60 to the display driver IC 300B or 300B-1 in response to the interrupt INT. The display driver IC 300B or 300B-1 generates the rate control signals PCTL that are activated for each of the frames FRAME1 through FRAME60 and transmits the rate control signals PCTL to the display 410.

In FIG. 8, “ACT” denotes the activated period of the rate control signals PCTL. The display 410 refreshes the display data DDATA corresponding to each of the frames FRAME1 through FRAME60 in response to the rate control signals PCTL activated for each of the frames FRAME1 through FRAME60.

Referring to FIGS. 6 through 8, in a second case CASE2, when the panel refresh rate is 30 Hz, the host 200C or 200C-1 transmits the video stream DPAC for each of the odd-numbered frames FRAME1, FRAME3, FRAME5, . . . to the display driver IC 300B or 300B-1 in response to the interrupt INT. The display driver IC 300B or 300B-1 generates the rate control signals PCTL that are activated for each of the odd-numbered frames FRAME1, FRAME3, FRAME5, . . . and transmits the rate control signals PCTL to the display 410.

In FIG. 8, “INACT” denotes the deactivated period of the rate control signals PCTL. The display 410 does not perform panel refresh in response to the deactivated rate control signals PCTL.

During the first and second frames FRAME1 and FRAME2, the same display data DDATA is displayed. During the third and fourth frames FRAME3 and FRAME4, the same display data DDATA is displayed. However, a conventional host cannot adjust the panel refresh rate and therefore transmits a video stream PA for each of the frames FRAME1 through FRAME60 to a display driver IC connected to the host.

In other words, when the panel refresh rate is reduced to 30 Hz, the power consumption of the display 410 according to the current embodiments of the inventive concepts is decreased to half the power consumption of a conventional display that is refreshed at 60 Hz.

Referring to FIGS. 6 through 8, in a third case CASE3, when the panel refresh rate is 20 Hz, the host 200C or 200C-1 transmits the video stream DPAC for each of the frames FRAME1, FRAME4, . . . to the display driver IC 300B or 300B-1 in response to the interrupt INT. The display driver IC 300B or 300B-1 generates the rate control signals PCTL that are activated for each of the frames FRAME1, FRAME4, . . . and transmits the rate control signals PCTL to the display 410.

During the first and second frames FRAME2 and FRAME3, the display 410 does not perform panel refresh in response to the deactivated rate control signals PCTL.

During the first through third frames FRAME1 through FRAME3, the same display data DDATA is displayed. During the fourth through sixth frames FRAME4 and FRAME6, the same display data DDATA is displayed. However, a conventional host cannot adjust the panel refresh rate and therefore transmits the video stream PA for each of the frames FRAME1 through FRAME60 to a display driver IC connected to the host. In other words, when the panel refresh rate is reduced to 20 Hz, the power consumption of the display 410 is decreased to one-third of the power consumption of a conventional display that is refreshed at 60 Hz.

Referring to FIGS. 6 through 8, in a fourth case CASE4, when the panel refresh rate is 1 Hz, the host 200C or 200C-1 transmits the video stream DPAC corresponding to the first frame FRAME1 to the display driver IC 300B or 300B-1 in response to the interrupt INT. The display driver IC 300B or 300B-1 generates the rate control signals PCTL that are activated for the first frame FRAME1 and transmits the rate control signals PCTL to the display 410.

During the second through 60th frames FRAME2 through FRAME60, the display 410 does not perform panel refresh in response to the deactivated rate control signals PCTL.

During the first through 60th frames FRAME1 through FRAME60, the same display data DDATA is displayed. However, a conventional host cannot adjust the panel refresh rate and therefore transmits the video stream PA for each of the frames FRAME1 through FRAME60 to a display driver IC connected to the host. In other words, when the panel refresh rate is reduced to 1 Hz, the power consumption of the display 410 is decreased to 1/60 of the power consumption of a conventional display that is refreshed at 60 Hz.

As shown in FIG. 8, when the panel refresh rate is set to N (where N is a natural number), the host 200C or 200C-1 may transmit N video streams DPAC per second to the display driver IC 300B or 300B-1, the display driver IC 300B or 300B-1 may generate N rate control signals PCTL activated per second, and the display 410 may perform panel refresh N times per second. In the data processing systems 100C and 100C-1 illustrated in FIGS. 6 and 7, panel refresh is performed in the display 410 based on the rate control signals PCTL.

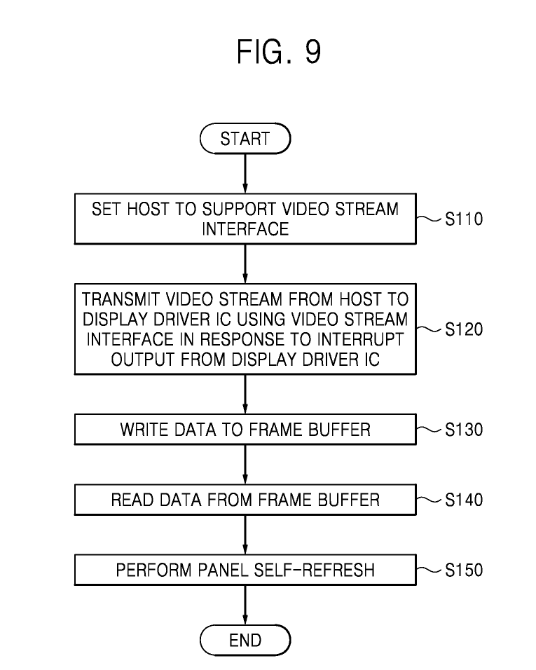

FIG. 9 is a flowchart of a method of operating the data processing system 100A or 100A-1 illustrated in FIG. 1 or 2 according to some embodiments of the inventive concepts. Referring to FIGS. 1 through 5 and FIG. 9, each of the hosts 200A, 200A-1, 500 and 500A that can support a video stream interface is set to support the video stream interface in operation S110.

When it is necessary to transmit the video stream DPAC to the display driver IC 300A or 300A-1, the host 200A, 200A-1, 500 or 500A transmits the video stream DPAC to the display driver IC 300A or 300A-1 using the video stream interface in response to the interrupt INT output from the display driver IC 300A or 300A-1 in operation S120.

The data DATA restored by the RX I/F 310A or 310B is written to the frame buffer 330 based on the clock CLKm and the data enable signal DE in operation S130. The memory controller 320 reads the data DATA from the frame buffer 330 in response to the clock CLK and the read enable signal PEN in operation S140.

The memory controller 320 and the timing controller 340A read the data DATA from the frame buffer 330 when panel self-refresh is necessary and transmit the display data DDATA corresponding to the data DATA that has been read to the display 400. Accordingly, the panel self-refresh is performed on the panel 400 by the display driver IC 300A or 300A-1 including the frame buffer 330 in operation S150.

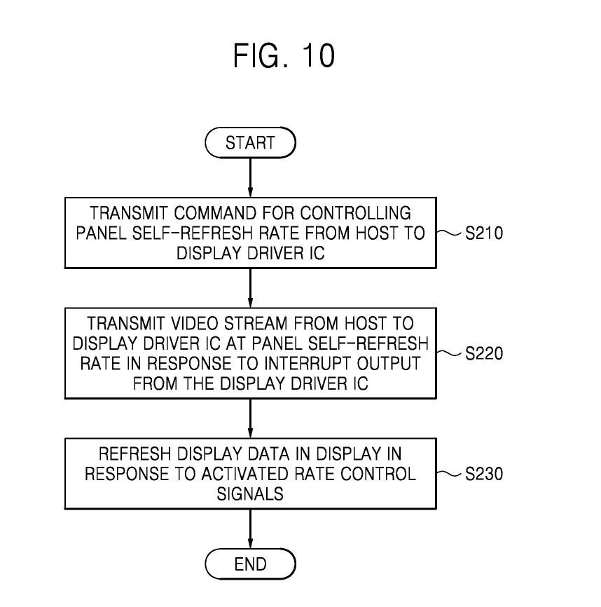

FIG. 10 is a flowchart of a method of operating the data processing system 100C or 100C-1 illustrated in FIG. 6 or 7 according to some embodiments of the inventive concepts. Referring to FIGS. 6 through 10, the host 200C or 200C-1 generates a command when it is necessary to adjust a panel self-refresh rate.

The host 200C or 200C-1 transmits the command to the display driver IC 300B or 300B-1 in operation S210. The host 200C or 200C-1 transmits the video stream DPAC to the display driver IC 300B or 300B-1 at the panel self-refresh rate in response to the interrupt INT output from the display driver IC 300B or 300B-1 in operation S220. The display 410 performs panel refresh in response to the rate control signals PCTL activated in operation 230.

As described above, according to some embodiments of the inventive concepts, a host set to a support video stream interface transmits a video stream to a display driver IC using the video stream interface in response to an interrupt output from the display driver IC when the video stream is to be transmitted to the display driver IC.

While the inventive concepts has been particularly shown and described with reference to exemplary embodiments thereof, it will be understood by those of ordinary skill in the art that various changes in forms and details may be made therein without departing from the spirit and scope of the inventive concepts as defined by the following claims.

What is claimed is:

1. A method of operating a system including a host, a display driver IC and a panel, the method comprising:
setting the host to support a video stream interface;
determining whether to transmit a video stream to the display driver IC; and
transmitting, by the host, the video stream to the display driver IC using the video stream interface in response to an interrupt output from the display driver IC based on the determination.

2. The method of claim 1, wherein the setting sets the host to support the video stream interface using firmware.

3. The method of claim 1, wherein the interrupt is a control signal for controlling transmission timing of the video stream to be transmitted to the display driver IC.

4. The method of claim 1, further comprising:
determining, by the host, whether the video stream is still image data or moving image data; and
controlling whether to transmit the video stream based on the determining whether the video stream is still image data or moving image data.

5. The method of claim 1, wherein the video stream interface supports a mobile industry processor interface (MIPI) video mode,
the video stream includes synchronous signals and data,
the host transmits the video stream to the display driver IC using a first clock, and
the interrupt is a tearing effect (TE) signal.

6. The method of claim 5, further comprising:
restoring, by the display driver IC, a data enable signal and the data from the video stream; and
writing, by the display driver IC, the data to a frame buffer implemented in the display driver IC using a write clock related to the first clock and the restored data enable signal.

7. The method of claim 6, further comprising:
generating an internal clock using an oscillator implemented in the display driver IC;
generating a second clock and an enable signal related to panel self-refresh using the internal clock;
reading the data from the frame buffer using the enable signal and a read clock related to the second clock; and
transmitting video data related to the data read to the panel.

8. The method of claim 1, wherein, when the system further comprises a main host which outputs first data in a first data format to the host, further comprising:
converting, by the host, the first data into the video stream in a second data format, and wherein
the main host is implemented as a first chip and the host is implemented as a second chip.

9. The method of claim 1, wherein the video stream includes a first clock and data.

10. The method of claim 9, further comprising:
restoring, by the display driver IC, a data enable signal, the data and the first clock from the video stream; and
writing, by the display driver IC, the restored data to a frame buffer implemented in the display driver IC using a write clock related to the restored first clock and the restored data enable signal.

11. The method of claim 1, further comprising:
transmitting, by the host, a command for adjusting a panel refresh rate of the panel to the display driver IC; and
transmitting, by the host, the video stream to the display driver IC at the panel refresh rate.

12. The method of claim 11, further comprising:
restoring, by the display driver IC, data and a data enable signal from the video stream;
decoding, by the display driver IC, the command;
generating a decoded command;
writing, by the display driver IC, the restored data to a line buffer using the restored data enable signal and a first clock received from the host;
generating, by the display driver IC, an internal clock using an oscillator implemented in the display driver IC;
generating, by the display driver IC, a rate control signal for adjusting the panel refresh rate using the decoded command and the internal clock; and
transmitting the rate control signal to the panel.

13. The method of claim 11, further comprising:
restoring, by the display driver IC, data, a clock, and a data enable signal from the video stream, the video stream including an embedded clock and the data;
decoding, by the display driver IC, the command;
generating a decoded command;
writing, by the display driver IC, the restored data to a line buffer using the restored data enable signal and the restored clock;
generating, by the display driver IC, an internal clock using an oscillator implemented in the display driver IC; and
generating, by the display driver IC, rate control signals for adjusting the panel refresh rate using the decoded command and the internal clock; and
transmitting the rate control signals to the panel.

14. A display driver IC comprising:
a receive interface configured to receive a video stream and a clock from a host and to restore a data enable signal and data from the video stream;
a frame buffer;
an oscillator configured to generate an internal clock;
a timing controller configured to transmit an interrupt for controlling transmission timing of the video stream using the internal clock and to generate control signals related to panel self-refresh; and
a memory controller configured to write the restored data to the frame buffer using a write clock related to the clock and the restored data enable signal.

15. The display driver IC of claim 14, wherein
the memory controller transmits the data from the frame buffer to the timing controller using a read clock related to first control signals among the control signals, and
the timing controller transmits the data and second control signals related to display of the data among the control signals to the panel.

16. A data processing system comprising:
a host;
an external memory;
a display; and
a display driver IC including:
a receive interface configured to receive a video stream including an embedded clock and data output from a host and to restore a data enable signal, the data, and the clock from the video stream;
a frame buffer;
an oscillator configured to generate an internal clock;
a timing controller configured to transmit an interrupt for controlling transmission timing of the video stream using the internal clock and to generate control signals related to panel self-refresh; and
a memory controller configured to write the restored data to the frame buffer using a write clock related to the clock and the restored data enable signal.

17. The data processing system of claim 16, wherein the memory controller transmits the data from the frame buffer to the timing controller using a read clock related to first control signals among the control signals and the timing controller transmits the data and second control signals related to display of the data among the control signals to the panel.

18. The data processing system of claim 16, further comprising:
a camera.

19. The data processing system of claim 16, wherein the data processing system processes at least one of still image data and moving image data.

20. The data processing system of claim 16, the data processing system is implemented as a smart phone, a tablet personal computer, a digital camera, or a wearable computer.
